(19) United States
(12) Patent Application Publication
(10) Pub. No.: US 2013/0017096 A1
(43) Pub. Date: Jan. 17, 2013

(54) REDUCING RADAR INTERFERENCE FROM WIND TURBINES

(71) Applicant: Charles Holley, Corpus Christi, TX (US)

(72) Inventor: Charles Holley, Corpus Christi, TX (US)

(21) Appl. No.: 13/182,005

(22) Filed: Jul. 13, 2011

(51) Int. Cl. F01D 5/14; G01S 13/00; F03D 11/04

(52) U.S. Cl. 416/241 A; 416/244 R; 342/89

(57) ABSTRACT

A wind turbine including components formed from or coated in a radar absorptive material. A method for scanning an area having one wind turbines and ignoring the radar interference therefrom is also provided.

### BACKGROUND OF INVENTION

This application relates generally to wind turbines and more particularly to eliminating or reducing radar interference from wind turbines.

### SUMMARY

Wind turbines are an important and valuable source of alternative energy. Wind turbines convert kinetic energy from the wind into mechanical energy, which may then be converted into electrical energy. As crude oil prices continue to increase such alternative energy sources are growing in importance. Moreover, in addition to power generation, wind turbines are environmentally sound and produce very little, if any, environmental waste.

One downside of wind turbines is that they typically interfere with radar scanning (e.g. Doppler, etc.). This may be problematic for radar scanning for the purposes of defense monitoring as well as weather scanning and tracking. Therefore, there exists a significant need for reducing or eliminating radar interference from wind turbines.

In one embodiment, a wind turbine comprises a foundation; a tower extending from the foundation; a nacelle coupled to the tower, the nacelle encompassing a gearbox and a generator; and a rotor rotatably coupled to the nacelle, the rotor comprising a hub and a plurality of blades extending from the hub, wherein at least a portion of blades are formed from a radar absorbent material.

In an alternative embodiment, a wind turbine comprises a foundation; a tower extending from the foundation; a nacelle coupled to the tower, the nacelle encompassing a gearbox and a generator, wherein the generator is coated with a radar absorbent material; and a rotor rotatably coupled to the nacelle, the rotor comprising a hub and a plurality of blades extending from the hub.

In yet another alternative embodiment, method for reducing radar interference from wind turbines comprises providing a wind turbine having a foundation at a ground level, wherein the wind turbine extends less than 500 feet from the ground level; radar scanning an area including the wind turbine; and ignoring radar signals received from less than 500 feet so that any radar signaling from the turbine is ignored.

### BRIEF DESCRIPTION OF THE DRAWINGS

The drawings, when considered in connection with the following description, are presented for the purpose of facilitating an understanding of the subject matter sought to be protected.

FIG. 1 is a front view of a wind turbine;

FIG. 2 is a side view of a wind turbine; and

FIG. 3 is a method of radar scanning an area having one or more wind turbines.

### DETAILED DESCRIPTION

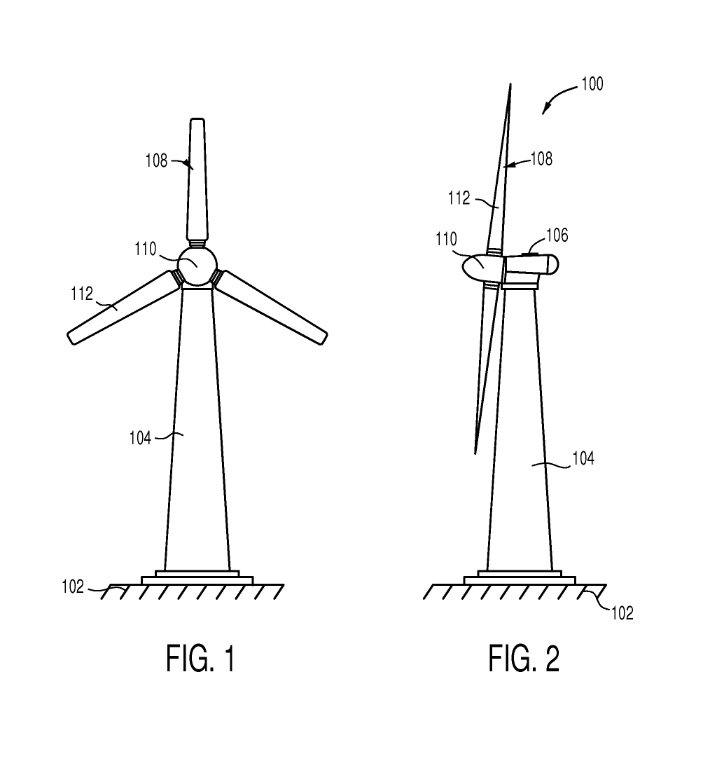

Referring now to FIGS. 1 and 2, an illustrative wind turbine 100 is shown. The wind turbine includes a foundation 102 from under which the electrical connections extend into the remainder of the turbine 100. A tower 104 extends from the foundation 102 and terminates at a nacelle 106. The tower is mounted to the foundation using standard techniques used with current turbines. The nacelle 106 is a housing that encompasses various components of the turbine 100, including but not limited to a generator and a gearbox. A rotor 108 is rotatably coupled to the nacelle 106. The rotor includes a hub 110 and a plurality of blades 112 extending from the hub 110. As is commonly known in the art, the wind turbine 100 converts kinetic energy from the wind into mechanical energy, by way of rotation of the rotor 108, which may in turn be converted to electrical energy.

In one embodiment, at least a portion of each blade 112 is formed from a radar absorbent material. The entire blade 112 may be formed from a radar absorbent material. Alternatively, the core of the blade 112 may be coated or otherwise covered with a radar absorbent material.

In one embodiment, the radar absorbent is a composite material. Any sufficiently radar absorbent composite material may be employed and is considered within the scope of the present disclosure. In one embodiment, the composite material includes a polymer matrix and a reinforcement material. The polymer matrix may take any suitable form. Illustrative and non-limiting polymer matrices include, but are not limited to, at least one of a polyester, vinyl ester, epoxy, phenolic, polyimide, polyamide, polypropylene, shape memory polymer, and PEEK. In yet another embodiment, a light application of ferrite may be employed. Other suitable polymers will be apparent to those skilled in the art and are considered within the scope of the present disclosure. Likewise, any suitable reinforcement material may be employed. Illustrative and non-limiting reinforcement materials include, without limitation, at least one of a plurality of fibers (carbon fiber, glass, etc.) and ground minerals. Other suitable reinforcement materials will be apparent to those skilled in the art and are considered within the scope of the present disclosure.

The radar absorbent blades 112 may be formed from any suitable process for forming turbine blades 112. In one embodiment, the blades 112 may be formed using a molding process. Suitable molding processes include, without limitation vacuum molding, pressure bag molding, autoclave molding, resin transfer molding, press molding, transfer molding, pultrusion molding, filament winding, casting, centrifugal casting and continuous casting. Other forming process may be employed as well, including but not limited to CNC filament winding, vacuum infusion, wet lay-up, compression molding, and thermoplastic molding. It will be appreciated that the blades 112 may be formed using any suitable process and remain within the scope of the present disclosure.

In an alternative embodiment, the generator within the nacelle 106 may be coated with a radar absorbent material. Additionally, the all or a portion of the exterior surface of the nacelle 106 may be coated with a radar absorbent material. In addition to the aforementioned composite material(s), the coating(s) may also be a ferrite material. For the purposes of this disclosure, ferrite material may include, but is not limited to, ferrite (iron), iron or iron alloys with a body centered cubic crystal structure; ferrite (magnet) (e.g. Fe3O4 or BaFe12O19), ferromagnetic ceramic materials; and calcium aluminoferrite. One or more radar absorbent materials may be used in the coatings. Moreover, the coating(s) may be applied with any suitable coating technique and remain within the scope of the present disclosure. For example, a ferrite coating can be applied by spraying or brushing. Further, ferrite composites such as an iron-ferrite composite, ferromagnetic ceramic, ferrite bead, ferrite core, and calcium aluminoferrite can be used for coating.

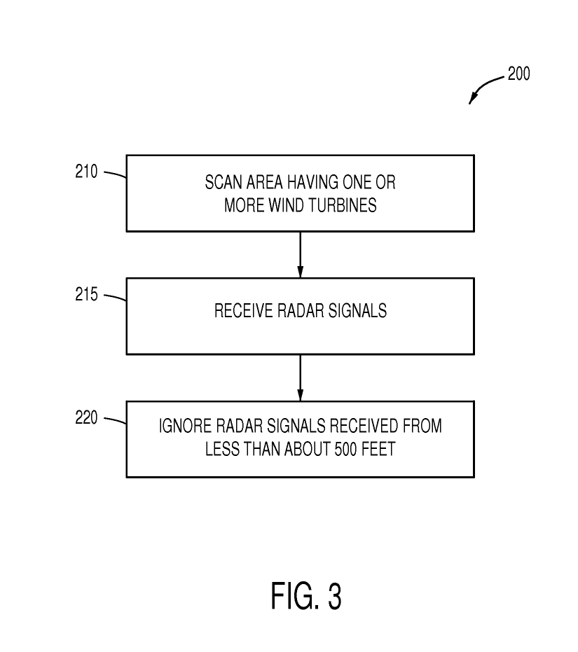

Referring now to FIG. 3, in an alternative embodiment, a method 200 is provided. First, an area having one or more wind turbines is scanned with radar (e.g. Doppler, etc.) 210. The wind turbines may or may not include radar absorptive materials and previously described. Next, radar signals from the scanning are then received 220. Next, any radar signals received from about 500 feet or less are ignored for the purposes of further analyzing the radar scan 230. In one embodiment, radar signals received from below 500 feet absolute ground level (AGL) are ignored for the purposes of further analyzing the radar signals.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A wind turbine comprising:
a foundation;
a tower extending from the foundation;
a nacelle coupled to the tower, the nacelle encompassing a gearbox and a generator; and
a rotor rotatably coupled to the nacelle, the rotor comprising a hub and a plurality of blades extending from the hub, wherein at least a portion of blades are formed from a radar absorbent material.

2. The turbine of claim 1 wherein the radar absorbent material is a composite material.

3. The turbine of claim 2 wherein the composite material includes a polymer matrix and a reinforcement material.

4. The turbine of claim 3 wherein the polymer matrix includes at least one of a polyester, vinyl ester, epoxy, phenolic, polyimide, polyamide, polypropylene, shape memory polymer, and PEEK.

5. The turbine of claim 4 wherein reinforcement material includes one of a plurality of fibers and ground minerals.

6. The turbine of claim 6 wherein the blades are formed from a molding process.

7. The turbine of claim 6 wherein the molding process is one of a vacuum molding, pressure bag molding, autoclave molding, and resin transfer molding.

8. A wind turbine comprising:
a foundation;
a tower extending from the foundation;
a nacelle coupled to the tower, the nacelle encompassing a gearbox and a generator, wherein the generator is coated with a radar absorbent material; and
a rotor rotatably coupled to the nacelle, the rotor comprising a hub and a plurality of blades extending from the hub.

9. The turbine of claim 8 wherein the radar absorbent material is a ferrite material.

10. The turbine of claim 8 wherein the nacelle is coated with a radar absorbent material.

11. A method for reducing radar interference from wind turbines comprising:
providing a wind turbine having a foundation at a ground level, wherein the wind turbine extends less than 500 feet from the ground level;
radar scanning an area including the wind turbine; and
ignoring radar signals received from less than 500 feet so that any radar signaling from the turbine is ignored.

12. The method of claim 11 wherein the turbine includes a rotor, wherein the rotor comprises a hub and a plurality of blades extending from the hub, wherein at least a portion of blades are formed from a radar absorbent material.

13. The method of claim 12 wherein the radar absorbent material is a composite material.

14. The method of claim 13 wherein the composite material includes a polymer matrix and a reinforcement material.

15. The method of claim 14 wherein the polymer matrix includes at least one of a polyester, vinyl ester, epoxy, phenolic, polyimide, polyamide, polypropylene, shape memory polymer, and PEEK.

16. The method of claim 15 wherein reinforcement material includes one of a plurality of fibers and ground minerals.

17. The method of claim 11 wherein the turbine includes a nacelle encompassing a gearbox and a generator, wherein the generator is coated with a radar absorbent material.

18. The method of claim 17 wherein the radar absorbent material is a ferrite material.

19. The method of claim 18 wherein the nacelle is coated with a radar absorbent material.

20. The method of claim 19 wherein the radar absorbent material is a ferrite material.
